(19) United States
(12) Patent Application Publication
(10) Pub. No.: US 2023/0263197 A1
(43) Pub. Date: Aug. 24, 2023

(54) Structure of a Machine for Cooking Snacks in a Salt Bath

(71) Applicant: ARCO SRL, Gazzo Padovano (PD) (IT)

(72) Inventor: Claudio Malaman, Camisano Vicentino (VI) (IT)

(21) Appl. No.: 18/006,461

(22) PCT Filed: Jul. 21, 2021
(86) PCT No.: PCT/IB2021/056585

§ 371 Date: Jan. 23, 2023

(30) Foreign Application Priority Data
Jul. 24, 2020 (IT) 102020000017965

(51) Int. Cl. A23L 5/10; A23L 19/18

(52) U.S. Cl. CPC A23L 5/19; A23L 19/18

(57) ABSTRACT

A structure of a machine for cooking snacks in a salt bath, includes: a load-bearing frame; a mixing drum, having a tubular body extending along a main axis, an inlet mouth, an outlet mouth and a feed screw, inside the tubular body, configured to force a plurality of elements placed inside the tubular body to advance from the inlet mouth towards the outlet mouth; a containment jacket, which encloses the mixing drum and is integral with it; a recirculation gap defined between the mixing drum and the containment jacket; a sieving zone for separating the elements, inside the tubular body, from a bath of granular material in which the elements are immersed; a heater configured to heat the bath of granular material; motor driver for continuously rotating the containment jacket and the mixing drum integral with it. The main axis is tilted with respect to a reference horizontal plane.

### BACKGROUND OF THE INVENTION

### 1. The Field of the Invention

The invention relates to a structure of a machine for cooking snacks in a salt bath.

### 2. The Relevant Technology

The term ‘snacks’ refers in particular to those made from tubers, such as potatoes, as well as those made from cereals; such snacks are made available for purchase in sealed packages.

Nowadays, salt bath cooking procedures are becoming increasingly popular to prepare such snacks.

These salt bath processes are preferred to traditional cooking processes, such as frying or hot-air cooking, as they make it possible to overcome health issues assith oil bath cooking and the drawbacks related to a defectice cooking associated with hot-air cooking.

In order to carry out cooking process of the salt bath type, specific machines are generally used to cook snacks such as crisps and the like.

Such machines for cooking snacks in a salt bath comprise:
a mixing drum, with a horizontal axis, containing, inside thereof, a feed screw configured to force the snacks immersed in a salt bath to advance from an inlet mouth of the drum towards an outlet mouth of the same drum placed in a position opposite to the inlet mouth
an external containment jacket, inside which the mixing drum oprates
means for heating the salt bath;
motor drive means for the rotation of the mixing drum.

In order to seperate the snacks from the salt bath near the outlet mouth of the mixing drum, the latter is generally equipped with an end portion comprising an ordered array of radial through holes through which tha salt exits from inside the drum to fall into the gap between the mixing drum and the containment jacket, while the snacks proceed towards the oultlet mouth and exit the latter to fall on conveying means towards the packaging machines.

In known machines, the salt bath is recirculated towards the inlet mouth of the mixing drum by means of a salt recirculation screw, defined in the gap between the mixing drum and the containment jacket.

This salt recirculation screw is configured to push the salt bath towards the drum inlet mouth, intercepting such salt bath as it falls from the radial hole portion of the mixing drum.

These types of machines for cooking snacks in a salt bath, though well known and appreciated, have some drawbacks.

A first major drawback consists in the undesired grinding of the salt granules making up the salt bath.

In fact, the more crushed and finer the salt is, the more it tends to stick to the snack, with the serious risk of excessively salting the snack.

This grinding of the grains of the salt bath is mainly due to the stirring of the grains making up the salt bath, which then impact with each other, and to the continuous bumping and rubbing resulting from the contact with the surfaces of the feed and recirculation screws.

A further drawback associated to crushing salt granules consists in that the smaller the average size of the granules, the lesser the granule ability to store heat and release it slowly, i.e., the function of the salt bath is gradually reduced.

This drawback leads to the further undesirable consequence of halting the machine in order to replace the salt bath which has lost its functionality and effectiveness.

Another drawback of the machines for cooking snacks in a salt bath is the complex construction of the two screws, one inside the rotating drum and one outside it, which are relatively complex to be designed and assembled.

### SUMMARY OF THE DISCLOSURE

The task of the present invention is to develop a structure of a machine for cooking snacks in a salt bath capable of overcoming the aforementioned drawbacks and limits of the prior art.

In particular, one object of the invention is to develop a machine structure leading to a smaller crushing of the salt grains making up the salt bath.

Another object of the invention is to develop a machine structure that is easier to manufacture and assemble.

A further object of the invention is to develop a structure of a machine for cooking snacks in a salt bath that is as efficient, performing and robust as the machines of the prior art.

The above-mentioned task as well as the objects are achieved by a structure of a machine for cooking snacks in a salt bath according to claim 1.

Further characteristics of the machine structure according to claim 1 are described in the dependent claims.

### BRIEF DESCRIPTION OF THE DRAWINGS

The aforesaid task and objects, together with the advantages that will be mentioned below, are highlighted by the description of an embodiment of the structure of the machine for cooking snacks in a salt bath, which is given, by way of non-limiting explanation, with reference to the attached drawing tables, where:

FIG. 1 represents a first perspective view of a machine structure according to the invention;

FIG. 2 represents a second perspective view of a machine structure according to the invention;

FIG. 3 represents a side view of the machine structure according to the invention;

FIG. 4 represents a sectional side view of the machine structure according to the invention;

FIG. 5 represents a perspective cross section view of the machine structure according to the invention;

FIG. 6 represents a further perspective cross section view of the machine structure according to the invention;

FIG. 7 represents another perspective cross section view of the machine structure according to the invention;

FIG. 8 represents a detail of the machine structure according to the invention.

### DETAILED DESCRIPTION OF THE PREFERRED EMBODIMENTS

With reference to the mentioned figures, a structure of a machine for cooking snacks in a salt bath according to the invention is referred to, as a whole, by number 10.

This machine structure 10 comprises:
a load-bearing frame 11;
a mixing drum 12, clearly visible in FIG. 4, comprising in turn a tubular body 13 extending along a main axis X, an inlet mouth 14, an outlet mouth 15 and a feed screw 16, internal to the tubular body 13 and extending between the inlet mouth 14 and the outlet mouth 15, such feed screw 16 being configured to force a plurality of elements E, for example raw snacks to be cooked, placed inside the tubular body 13, to advance from the inlet mouth 14 towards the outlet mouth 15;
a containment jacket 17, which is configured to enclose the mixing drum 12 and is integral with it;
a recirculation gap 20 defined between the mixing drum 12 and the containment jacket 17;
a sieving zone 21 defined within the containment jacket 17 for separating the elements E, inside the tubular body 13, from a bath of granular material M, such as salt, in which these elements E are immersed;
heating means 18 configured to heat said bath of granular material M;
motor drive means 19 for rotating continuously said containment jacket 17 and said mixing drum 12 integral with it.

The inner compartment of the mixing drum 12 defines a cooking chamber for example for the elements E, i.e., for the snacks, which are cooked while remaining inside the bath of granular material M, i.e., in the salt bath.

The mixing drum 12, the containment jacket 17 and the recirculation gap 20 are coaxial to the main axis X.

The characteristic feature of the machine structure 10 according to the invention is that the main axis X is tilted with respect to a reference horizontal plane P, with the outlet mouth 15 being placed at a height above the ground H1 which is greater than a corresponding height above the ground H2 of said inlet mouth 14.

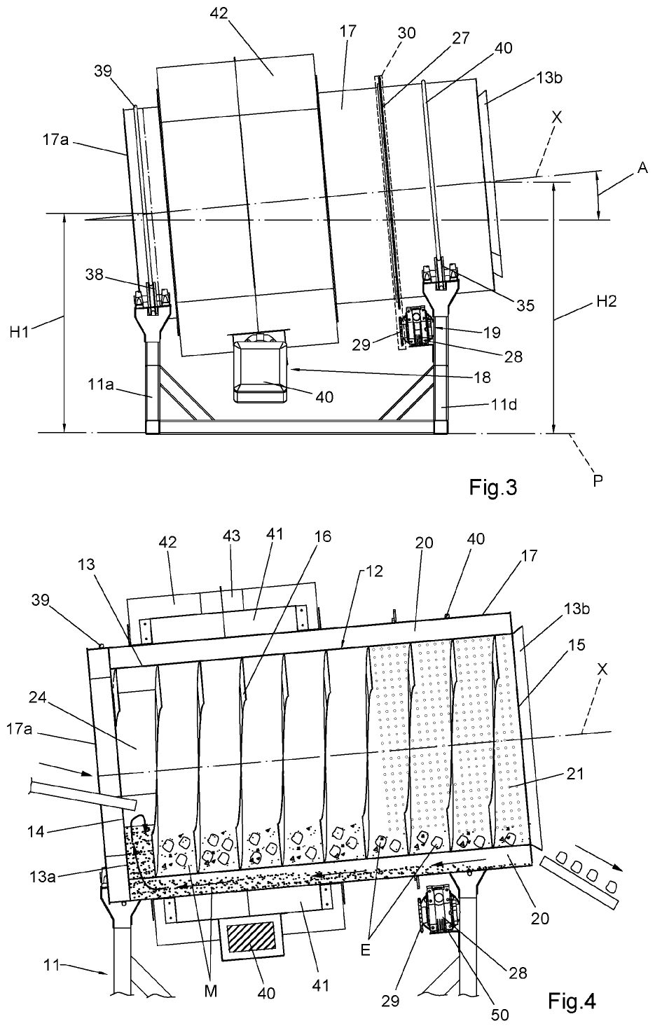

The heights H1 and H2 are shown, in FIG. 3, with reference to the centre of gravity of the inlet mouth 14 and the outlet mouth 15 respectively.

The containment jacket 17 thus defines a rotating chute for returning said granular material M from the outlet mouth 15 towards the inlet mouth 14.

The tubular body 13 consists of a cylindrical wall, whose axis of symmetry is the main axis X.

The sieving zone 21 is defined by an annular terminal portion of the tubular body 13, on the side of the outlet mouth 15, which annular terminal portion has an ordered array of through holes, which are shaped in such a way as to enable the passage of the granules comprising the granular material M, while preventing the passage of the elements E being cooked.

At the inlet mouth 14 there are transfer means 22, which are configured to move the granular material M, descending along the recirculation gap 20, from the same recirculation gap 20 to the inside of the mixing drum 12

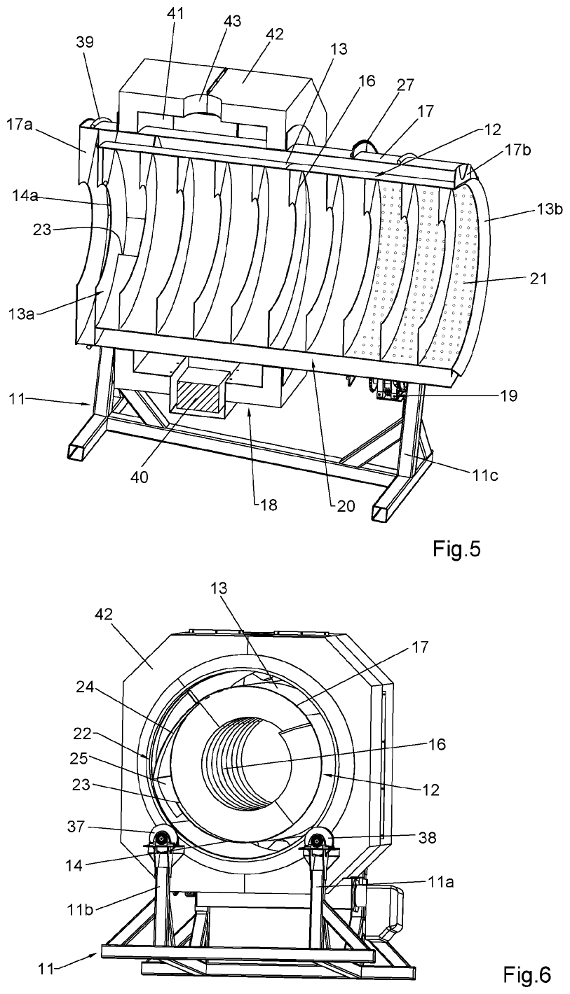

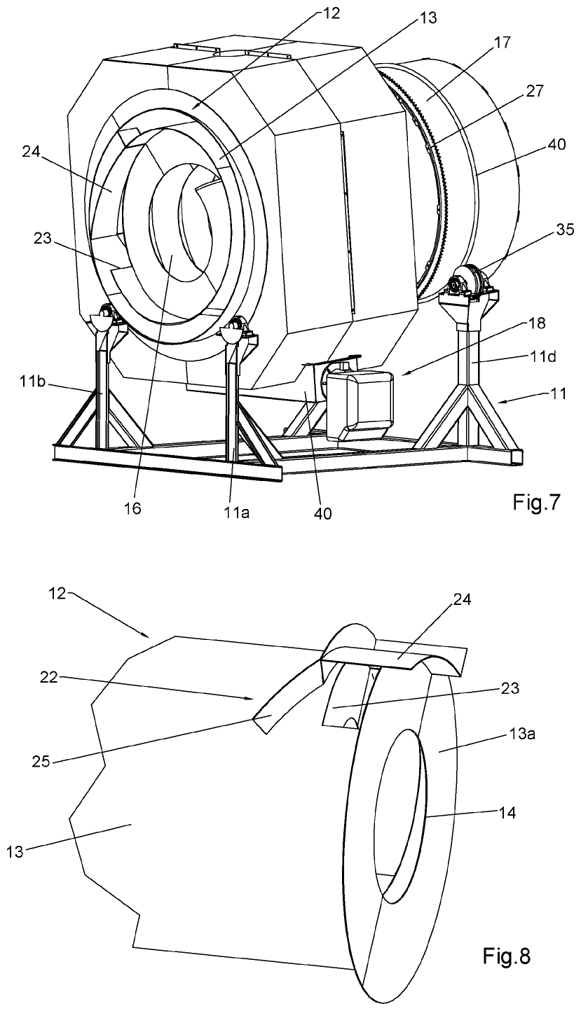

The transfer means 22 comprise:
a recharge opening 23, clearly visible in FIGS. 5 to 8, defined on the tubular body 13,
and a deflection plate 24 extending between the inner surface of the tubular body 13 and the containment jacket 17, said deflection plate 24 being configured to divert the granular material M from the recirculation gap 20 to the recharge opening 23.

The recharge opening 23 consists, for example, of a quadrangular window opened on the tubular body 13 near the inlet mouth 14.

The deflection plate 24 is arc-shaped and operates in the same way as a spoon, collecting the granular material M as it travels from the top to the bottom and again to the top of the rotational movement of such granular material M, and diverting said granular material M along a spiral path from the containment jacket 17, and thus from the recirculation gap 20, to the inside of the mixing drum 12.

The mixing drum 12 comprises the cylindrical wall of the tubular body 13 and a rear annular wall 13a, on which the inlet mouth 14 is defined.

The mixing drum 12 also comprises a truncated-cone discharge ring 13b extending from the front edge, i.e., from the part of the outlet mouth 15, of the tubular body 13.

Such truncated-cone discharge ring 13b has a diameter which increases in the direction moving away from the outlet mouth 15 outwards.

The containment jacket 17 also comprises a rear annular wall 17a, defining with the facing rear annular wall 13a of the mixing drum 12 a thermally-insulating gap.

The containment jacket 17 also includes a front reinforcement ring 17b, configured to connect the front end of the tubular body 13 with the corresponding front end of the containment jacket 17.

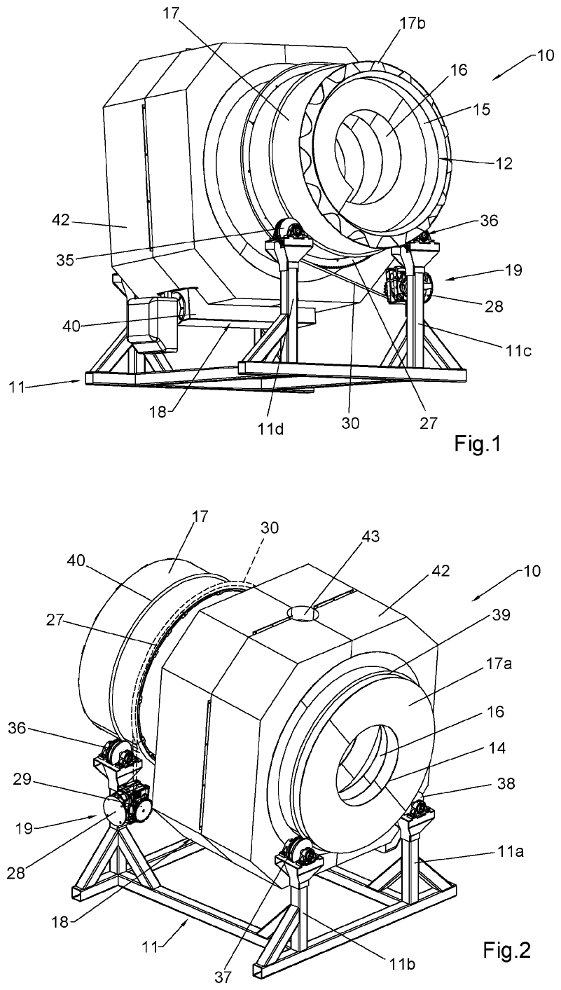

This front reinforcement ring 17b, shown for instance in FIG. 1, comprises a plurality of radial connecting bridges, between which an equal amount of air passage openings are defined.

The transfer means 22 also comprise an oblique collecting wall 25, clearly visible in FIG. 8, extending between the inner surface of the tubular body 13 and the containment jacket 17, not shown in FIG. 8, which oblique collecting 25 is configured to divert the granular material M towards the deflection plate 24.

In particular, such oblique collecting wall 25 extends according to section of a helical trajectory on the external surface of the tubular body 13.

Said oblique collecting wall 25 is thus configured to divert the granular material M by pushing it towards the recharge opening 23 during the rotational movement of the mixing drum 12 and the containment jacket 17.

A characteristic feature of the machine structure according to the invention is therefore that the recirculation gap 20, between the outlet mouth 15 and the deflection plate 24, is empty and is suitable to be crossed by the granular material M, without the latter encountering other components.

Since there are no screws for handling the granular material nor other elements in the recirculation gap 20, the granular material M is free to fall by gravity, sliding on the inner surface of the containment jacket 17, inside the recirculation gap 20, where the sliding is encouraged by the continuous rotation of the containment jacket 17, determining the continuous overturning of the same granular material M in the recirculation gap 20.

As exemplified in FIG. 3, the main axis X is preferably tilted, with respect to a reference horizontal plane P, by an angle A between 3° and 10°; for example, angle A measures 3° .

The heating means 18 are positioned so as to operate at least below the containment jacket 17 with respect to an arrangement of use of the machine structure 10.

In particular, in the herein described embodiment of the machine structure 10 according to the invention, which is to be understood as exemplary an annular heating channel 41 in turn defined inside a box-shaped body 42 enclosing a section of the containment jacket 17.

Hot air obviously circulates in the annular heating channel 41, which encloses the containment jacket 17. and not limiting the invention itself, the heating means 18 comprise a burner 40, connected to

The box-shaped body 42 is integral with the load-bearing frame 11.

This box-shaped body 42 is therefore crossed by the containment jacket 17.

The box-shaped body 42 has an upper hole 43 for exhausting fumes.

It must be understood that heating means may be different, based on the use of other fluids or on the use of electrical heating means, depending on the technical requirements.

In the embodiment of the invention described herein, which is of course to be understood as exemplifying and not limiting the invention, motor drive means 19 comprise:
a ring gear 27, coaxial to the main axis X and extending on the external surface of the containment jacket 17;
a motor 28, such as, though not exclusively, an electric motor, with a pinion 29;
a flexible longitudinal element 30, such as a belt or chain, for transmitting the torque from the pinion 29 to the ring gear 27.

The motor 28 is mounted on a bracket 50, visible in FIG. 4, in a position such that the rotation axis of the motor is parallel to the main axis X.

The load-bearing frame 11 comprises two rear pillars 11a, 11b and two front pillars 11c, 11d.

The front pillars 11c and 11d are higher than the two rear pillars 11a and 11b.

On each of the rear pillars 11a and 11b and front pillars 11c and 11d there is a support wheel, 35, 36, 37, 38 respectively, configured to support and guide the rotation of the containment jacket 17.

Each support wheel 35, 36, 37 and 38 has a rotation axis parallel to the main axis X.

In particular, in this embodiment, the support wheels 35, 36, 37 and 38 each have a perimeter groove coupling with a corresponding guide 39 and 40, which guide ring 39 and 40 is fixed so as to enclose the external surface of the containment jacket 17.

A rear guide ring 39 and a front guide ring 40 are present.

The rear pillars 11a and 11b and front pillars 11c and 11d, and the support wheels 35, 36, 37 and 38 define an assembly configured to allow the containment jacket 17 rotate continuously about the main axis X.

The term ‘continuous rotation’ means a rotation beyond 360° in the same rotation direction.

In order to return the granular material, i.e., the salt bath, back to the cooking chamber which is defined within the mixing drum 12, it is possible to take advantage of the tilting of the assembly consisting of the mixing drum 12 and containment jacket 17, and, in order to return the salt back to the inside of the mixing drum 12, the deflection plate 24 is arranged, which defines a chute that, by turning integrally with the containment jacket 17, picks up the salt from the area where it is deposited by gravity, i.e., the area below the rear end of the mixing drum 12, and takes it back, by sliding, into the mixing drum 12 where cooking takes place.

The sieving zone 21 consists of a perforated plate, so that the salt falls from the mixing drum 12 to the containment jacket 17, while the elements E, for example the snacks, expanded by the cooking process, being of a larger size, advance inside the mixing drum 12 until they come out frontally through the outlet mouth 15.

The cooked snacks then fall onto conveying means and are conveyed to packaging machines.

It has in practice been established that the invention achieves the intended task and objects.

In particular, the invention has developed a machine structure that involves less crushing of the salt grains making up the salt bath, due to the gravity descent of the salt bath into the recirculation gap 20, without a screw inside such gap forcing the salt bath to be further crushed.

In addition, the invention has developed a machine structure that is simpler to be manufactured and assembled, as it does not have all the components to force the salt bath back from the outlet mouth to the inlet mouth of the cooking chamber, i.e., of the mixing drum.

Furthermore, the invention has developed a structure of a machine for cooking snacks in a salt bath that is as efficient, performing and robust as the machines of the prior art.

The invention thus conceived is susceptible of several modifications and variations, all of which are within the scope of the inventive concept; moreover, all the details may be replaced by other technically equivalent elements.

In practice, the components and the materials used could be of any type, so long as they are compatible with the specific use, as well as the contingent shapes and dimensions, according to requirements and the state of the art.

Where the characteristics and techniques mentioned in any claim are followed by reference signs, such reference signs should be intended as having been added for the sole purpose of increasing the intelligibility of the claims and consequently such reference signs have no limiting effect on the interpretation of each element identified by way of example by such reference signs.

1. A structure of a machine for cooking snacks in a salt bath, comprising:
a load-bearing frame;
a mixing drum, comprising a tubular body extending along a main axis, an inlet mouth, an outlet mouth and a feed screw, inside said tubular body extending between said inlet mouth and said outlet mouth, said feed screw being configured to force a plurality of elements placed inside said tubular body to advance from said inlet mouth towards said outlet mouth;
a containment jacket, which is configured to enclose said mixing drum and is integral with it;
a recirculation gap defined between said mixing drum and said containment jacket;
a sieving zone defined within said containment jacket for separating said elements, inside said tubular body, from a bath of granular material in which said elements are immersed;
heating means configured to heat said bath of granular material;
motor drive means for continuously rotating said containment jacket and said mixing drum integral with it;
said mixing drum, said containment jacket and said recirculation gap being coaxial with respect to said main axis,
at said inlet mouth being present transfer means configured to move said granular material from said recirculation gap into said mixing drum,
characterised in that said main axis (X) is tilted with respect to a reference horizontal plane, with said outlet mouth which is placed at a height above the ground which is greater than a corresponding height above the ground of said inlet mouth.

2. The machine structure according to claim 1, wherein said containment jacket defines a rotating chute for returning said granular material from said outlet mouth towards said inlet mouth.

3. The machine structure according to claim 1, wherein said transfer means comprise a recharge opening defined on said tubular body and a deflection plate extending between the inner surface of said tubular body and said containment jacket, said deflection plate being configured to divert said granular material from said recirculation gap to said recharge opening.

4. The machine structure according to claim 1, wherein said recirculation gap, between said outlet mouth and said deflection plate, is empty and is available to be crossed by said granular material.

5. The machine structure according to claim 3, wherein said transfer means comprise an oblique collecting wall extending between the inner surface of said tubular body and said containment jacket, said oblique collecting wall being configured to divert said granular material towards said deflection plate.

6. The machine structure according to claim 1, wherein said heating means are positioned in such a way that they operate at least below said containment jacket with respect to an arrangement of use of the machine structure.

7. The machine structure according to claim 1, wherein said motor drive means comprise:
a ring gear, coaxial to said main axis and extending on the external surface of said containment jacket;
a motor with a pinion;
a flexible longitudinal element for transmitting the torque from said pinion to said ring gear.

8. The machine structure according to claim 1, wherein said load-bearing frame comprises two rear pillars and two front pillar, the front pillars being higher than the two rear pillars.

9. The machine structure according to claim 1, wherein, on each of said front and rear pillars, a support wheel configured to support and guide the rotation of said containment jacket is present.
